(19) United States
(12) Patent Application Publication
(10) Pub. No.: US 2022/0315050 A1
(43) Pub. Date: Oct. 6, 2022

(54) VEHICLE CONTROL DEVICE, ROUTE GENERATION DEVICE, VEHICLE CONTROL METHOD, ROUTE GENERATION METHOD, AND STORAGE MEDIUM

(71) Applicant: HONDA MOTOR CO., LTD., Tokyo (JP)

(72) Inventors: Yuki Sugano, Wako-shi (JP); Nobuharu Nagaoka, Wako-shi (JP)

(21) Appl. No.: 17/665,644

(22) Filed: Feb. 7, 2022

(30) Foreign Application Priority Data
Mar. 31, 2021 (JP) 2021-059258

(51) Int. Cl. B60W 60/00; B60W 50/00; B60W 40/06; G01C 21/36; G06V 20/58

(52) U.S. Cl. CPC B60W 60/0011; B60W 50/0097; B60W 40/06; G01C 21/3602; G01C 21/3638; G01C 21/3647; G06V 20/58; B60W 2420/42; B60W 2556/40

(57) ABSTRACT

A vehicle control device includes a recognizer that recognizes a situation around a host vehicle based on a detection result of an object detection device including a camera and an action plan generator that generates an action plan of the host vehicle based on a recognition result of the recognizer about a situation around the host vehicle. The action plan generator generates an action plan for, when it is predicted that the camera will be backlit while the host vehicle is traveling, avoiding that the camera is backlit at a prediction point and a prediction timing when it is predicted that the camera will be backlit.

### CROSS-REFERENCE TO RELATED APPLICATION

Priority is claimed on Japanese Patent Application No. 2021-059258, filed Mar. 31, 2021, the content of which is incorporated herein by reference.

### BACKGROUND

### Field of the Invention

The present invention relates to a vehicle control device, a route generation device, a vehicle control method, a route generation method, and a storage medium.

### Description of Related Art

According to the related art, in order to implement a function of supporting the driving of a vehicle, a technology for recognizing an environment around the vehicle by using a plurality of detection means such as a millimeter wave radar, an infrared laser radar, a stereo camera, and a monocular camera has been developed. For example, a technology for restraining an erroneous operation of a driving support function due to erroneous recognition when a surrounding environment is recognized based on detection results of both imaging means and radar means has been proposed (Japanese Unexamined Patent Application, First Publication No. 2005-145396).

### SUMMARY

However, in the technology according to the related art, since the driving support function is limited when backlight to the imaging means is detected, the driving support function may not operate at a required timing.

The present invention is achieved in view of the problems described above, and one object of the present invention is to provide a vehicle control device, a route generation device, a vehicle control method, a route generation method, and a storage medium, by which it is possible to improve the robustness of a driving support function.

A vehicle control device, a route generation device, a vehicle control method, a route generation method, and a storage medium according to the invention employ the following configurations.

(1) A vehicle control device according to an aspect of the invention includes: a storage device configured to store a program; and a hardware processor, wherein the hardware processor executes the program stored in the storage device to perform a recognition process of recognizing a situation around a host vehicle based on a detection result of an object detection device including a camera and an action plan generation process of generating an action plan of the host vehicle based on a recognition result of the situation around the host vehicle, and in the action plan generation process, the hardware processor generates an action plan for, when it is predicted that the camera will be backlit while the host vehicle is traveling, avoiding that the camera is actually backlit at a prediction point and a prediction timing when it is predicted that the camera will be backlit.

(2) In the above aspect (1), the hardware processor generates a first backlight avoidance plan that is an action plan for preventing the host vehicle from traveling through the prediction point at the prediction timing, or a second backlight avoidance plan for traveling through the prediction point while positioning the camera so as not to be backlit by using a surrounding environment of the host vehicle at the prediction timing.

(3) In the above aspect (2), the hardware processor generates an action plan for bypassing the prediction point as the first backlight avoidance plan.

(4) In the above aspect (2), the hardware processor generates an action plan for traveling through the prediction point at a timing when the camera is not backlit, as the first backlight avoidance plan.

(5) In any one of the above aspects (2) to (4), the hardware processor generates an action plan for positioning the host vehicle to travel in a shadow of another vehicle present around the host vehicle, as the second backlight avoidance plan.

(6) In any one of the above aspects (1) to (5), the hardware processor predicts a positional relationship between the host vehicle and the sun based on a position of the host vehicle and time and determines whether the camera will be backlit based on a prediction result of the positional relationship and three-dimensional map information for around the position of the host vehicle.

(7) A vehicle control method according to an aspect of the invention is implemented by a computer that performs: an external recognition process of recognizing a situation around a host vehicle based on a detection result of an object detection device including a camera; and an action plan generation process of generating an action plan of the host vehicle based on a recognition result of a situation around the host vehicle, wherein, in the action plan generation process, the hardware processor generates an action plan for, when it is predicted that the camera will be backlit while the host vehicle is traveling, avoiding that the camera is actually backlit at a prediction point and a prediction timing when it is predicted that the camera will be backlit.

(8) A non-transitory computer readable storage medium storing a program according to an aspect of the invention causes a computer to perform: an external recognition process of recognizing a situation around a host vehicle based on a detection result of an object detection device including a camera; and an action plan generation process of generating an action plan of the host vehicle based on a recognition result of a situation around the host vehicle, wherein, in the action plan generation process, the hardware processor generates an action plan for, when it is predicted that the camera will be backlit while the host vehicle is traveling, avoiding that the camera is actually backlit at a prediction point and a prediction timing when it is predicted that the camera will be backlit.

(9) A route generation device according to an aspect of the invention includes a storage device configured to store a program; and a hardware processor, wherein the hardware processor executes the program stored in the storage device to perform a route determination process of accepting input of information on a departure point and a destination and determining a travel route from the departure point to the destination based on the input information on the departure point and the destination and map information including a road shape, and in the route determination process, the hardware processor predicts a positional relationship between a host vehicle and the sun based on a position of the host vehicle and time, and determines a travel route for preventing a camera mounted on the host vehicle to capture an image of an area in front of the host vehicle from being backlit, based on a prediction result of the positional relationship and three-dimensional map information for around the position of the host vehicle.

(10) A route generation method according to an aspect of the invention is implemented by a computer that performs a route determination process of receiving information on a departure point and a destination and determining a travel route from the departure point to the destination based on the input information on the departure point and the destination and map information including a road shape, wherein, in the route determination process, the hardware processor predicts a positional relationship between a host vehicle and the sun based on a position of the host vehicle and time, and determines a travel route for preventing a camera mounted on the host vehicle to capture an image of an area in front of the host vehicle from being backlit, based on a prediction result of the positional relationship and three-dimensional map information for around the position of the host vehicle.

(11) A non-transitory computer readable storage medium storing a program according to an aspect of the invention causes a computer to perform a route determination process of receiving information on a departure point and a destination and determining a travel route from the departure point to the destination based on the input information on the departure point and the destination and map information including a road shape, wherein, in the route determination process, the hardware processor predicts a positional relationship between a host vehicle and the sun based on a position of the host vehicle and time, and determines a travel route for preventing a camera mounted on the host vehicle to capture an image of an area in front of the host vehicle from being backlit, based on a prediction result of the positional relationship and three-dimensional map information for around the position of the host vehicle.

According to (1) to (11), it is possible to improve the robustness of a driving support function.

### BRIEF DESCRIPTION OF THE DRAWINGS

FIG. 1 is a configuration diagram of a vehicle system using a vehicle control device according to an embodiment.

FIG. 2 is a functional configuration diagram of a first controller and a second controller.

FIG. 3 is a diagram showing an example of the correspondence relationships between a driving mode, a control state of a host vehicle, and a task.

FIG. 4 is a diagram showing an example of generating an action plan for traveling on a detour route as an example of a first backlight avoidance plan in an embodiment.

FIG. 5 is a diagram showing an example of generating, as an example of the first backlight avoidance plan in the embodiment, an action plan for traveling through a point (position), which is estimated as a backlight prediction point, at the timing when a camera is not backlit.

FIG. 6 is a diagram for explaining an example of a second backlight avoidance plan in the embodiment.

FIG. 7 is a flowchart showing an example of the flow of a first backlight avoidance process in which an action plan generator in an automated driving control device of the embodiment avoids backlight by generating the first backlight avoidance plan or the second backlight avoidance plan.

FIG. 8 is a flowchart showing an example of the flow of a second backlight avoidance process in which a route determiner in a navigation device of the embodiment determines a backlight avoidance route.

### DESCRIPTION OF EMBODIMENTS

Hereinafter, an embodiment of a vehicle control device, a route generation device, a vehicle control method, a route generation method, and a storage medium of the present invention will be described with reference to the drawings. As used throughout this disclosure, the singular forms “a”, “an”, and “the” include plural reference unless the context clearly dictates otherwise.

Overall Configuration

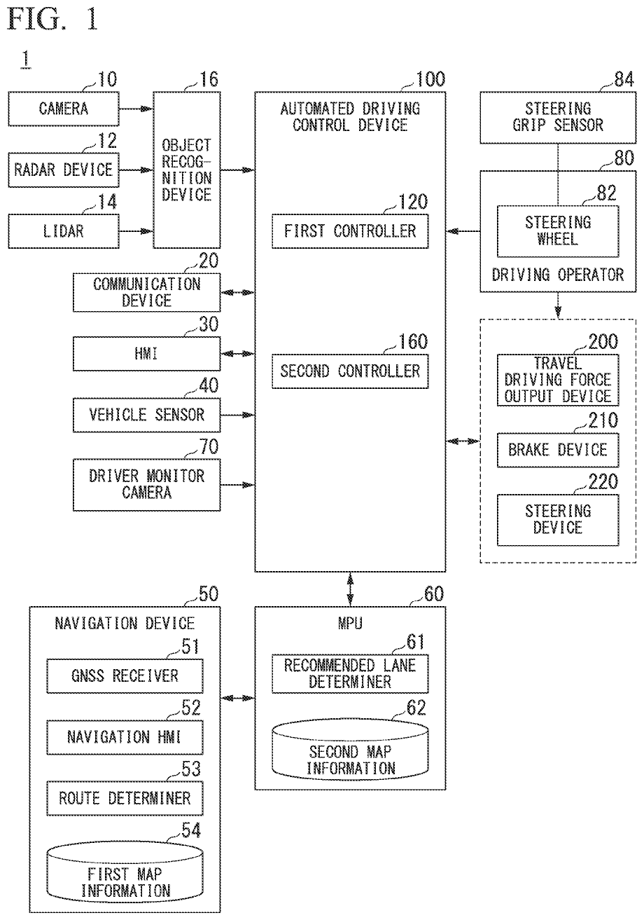

FIG. 1 is a configuration diagram of a vehicle system 1 using a vehicle control device according to an embodiment. A vehicle, in which the vehicle system 1 is installed, is a vehicle with two wheels, three wheels, four wheels, and the like, for example, and its driving source is an internal combustion engine such as a diesel engine and a gasoline engine, an electric motor, or a combination thereof. The electric motor operates by using power generated by a generator connected to the internal combustion engine or power discharged from a secondary cell or a fuel cell.

The vehicle system 1 includes, for example, a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driver monitor camera 70, a driving operator 80, an automated driving control device 100, a travel driving force output device 200, a brake device 210, and a steering device 220. These devices and equipment are connected to one another via a multiplex communication line such as a controller area network (CAN) communication line, a serial communication line, a wireless communication network, and the like. The configuration shown in FIG. 1 is merely an example, and part of the configuration may be omitted or other configurations may be added.

The camera 10 is, for example, a digital camera using a solid-state imaging element such as a charge coupled device (CCD) and a complementary metal oxide semiconductor (CMOS). The camera 10 is mounted at arbitrary places on the vehicle (hereinafter, referred to as a host vehicle M) in which the vehicle system 1 is installed. In the case of capturing an image of an area in front of the host vehicle M, the camera 10 is mounted on an upper part of a front windshield, on a rear surface of a rear-view mirror, and the like. The camera 10, for example, periodically and repeatedly captures the surroundings of the host vehicle M. The camera 10 may be a stereo camera.

The radar device 12 emits radio waves such as millimeter waves to the surroundings of the host vehicle M, detects radio waves (reflected waves) reflected by an object, and detects at least a position (a distance and an orientation) of the object. The radar device 12 is mounted at arbitrary places on the host vehicle M. The radar device 12 may detect the position and the speed of the object by a frequency modulated continuous wave (FM-CW) scheme.

The LIDAR 14 emits light (or electromagnetic waves having a wavelength close to that of light) to the surroundings of the host vehicle M and measures scattered light. The LIDAR 14 detects a distance to a target based on a time from light emission to light reception. The emitted light is a pulsed laser beam, for example. The LIDAR 14 is mounted at arbitrary places on the host vehicle M.

The object recognition device 16 performs a sensor fusion process on results of detection by some or all of the camera 10, the radar device 12, and the LIDAR 14, thereby recognizing the position, the type, the speed and the like of an object. The object recognition device 16 outputs a recognition result to the automated driving control device 100. The object recognition device 16 may output the detection results of the camera 10, the radar device 12, and the LIDAR 14 to the automated driving control device 100 as are. The object recognition device 16 may be omitted from the vehicle system 1.

The communication device 20 communicates with other vehicles present around the host vehicle M, or communicates with various server devices via a wireless base station by using, for example, a cellular network, a Wi-Fi network, Bluetooth (registered trademark), dedicated short range communication (DSRC) and the like.

The HMI 30 presents various types of information to an occupant of the host vehicle M and receives an input operation of the occupant. The HMI 30 includes various display devices, speakers, buzzers, touch panels, switches, keys, and the like.

The vehicle sensor 40 includes a vehicle speed sensor that detects the speed of the host vehicle M, an acceleration sensor that detects acceleration, a yaw rate sensor that detects an angular velocity around a vertical axis, a direction sensor that detects the orientation of the host vehicle M, and the like.

The navigation device 50 includes, for example, a global navigation satellite system (GNSS) receiver 51, a navigation HMI 52, and a route determiner 53. The navigation device 50 stores first map information 54 in a storage device such as a hard disk drive (HDD) and a flash memory. The GNSS receiver 51 specifies the position of the host vehicle M based on a signal received from a GNSS satellite. The position of the host vehicle M may be specified or complemented by an inertial navigation system (INS) using the output of the vehicle sensor 40. The navigation HMI 52 includes a display device, a speaker, a touch panel, keys, and the like. The navigation HMI 52 may be partially or entirely shared with the aforementioned HMI 30. The route determiner 53 determines, for example, a route (hereinafter, referred to as a route on a map) to a destination, which is input by an occupant using the navigation HMI 52, from the position of the host vehicle M specified by the GNSS receiver 51 (or any input position) with reference to the first map information 54. The first map information 54 is, for example, information in which a road shape is expressed by links indicating a road and nodes connected by the links. The first map information 54 may include a road curvature, point of interest (POI) information, and the like. The route on the map is output to the MPU 60. The navigation device 50 may provide route guidance using the navigation HMI 52 based on the route on the map. The navigation device 50 may be implemented by, for example, functions of a terminal device such as a smart phone and a tablet terminal owned by an occupant. The navigation device 50 may transmit the current position and the destination to a navigation server via the communication device 20 and acquire a route equivalent to the route on the map from the navigation server.

In the navigation device 50 of the present embodiment, it is assumed that the first map information includes three-dimensional information of roads, structures other than the roads, topography, and the like (hereinafter, referred to as “three-dimensional map information”), and the route determiner 53 has a function of determining a travel route so that the camera 10 is not backlit while the host vehicle is traveling (hereinafter, referred to as a “backlight avoidance route”), based on the three-dimensional map information. Details of the function of determining the backlight avoidance route will be described below.

The navigation device 50 is implemented by, for example, a hardware processor such as a central processing unit (CPU) executing a program (software). Some or all of these components may be implemented by hardware (a circuit unit: including circuitry) such as a large scale integration (LSI), an application specific integrated circuit (ASIC), a field-programmable gate array (FPGA), and a graphics processing unit (GPU), or may be implemented by software and hardware in cooperation. The program may be stored in advance in a storage device (storage device including a non-transitory storage medium) such as an HDD and a flash memory of the automated driving control device 100, or may be installed in the HDD and the flash memory of the automated driving control device 100 when a detachable storage medium (non-transitory storage medium) storing the program, such as a DVD and a CD-ROM, is mounted on a drive device. The navigation device 50 is an example of a “route generation device” of the present invention.

The MPU 60 includes, for example, a recommended lane determiner 61 and stores second map information 62 in a storage device such as an HDD and a flash memory. The recommended lane determiner 61 divides the route on the map provided from the navigation device 50 into a plurality of blocks (for example, divides the route on the map every 100 m in the vehicle travel direction), and determines a recommended lane for each block with reference to the second map information 62. The recommended lane determiner 61 determines, for example, which lane to travel from the leftmost lane. When there is a branch point on the route on the map, the recommended lane determiner 61 determines a recommended lane such that the host vehicle M can travel on a reasonable route for traveling to a branch destination.

The second map information 62 is more accurate map information than the first map information 54. The second map information 62 includes, for example, information on the center of a lane, information on the boundary of the lane, and the like. The second map information 62 may include road information, traffic regulation information, address information (address and postal code), facility information, telephone number information, information on prohibition sections where mode A and mode B to be described below are prohibited, and the like. The second map information 62 may be updated at any time by the communication device 20 communicating with another device.

The driver monitor camera 70 is, for example, a digital camera using a solid-state imaging element such as a CCD and a CMOS. The driver monitor camera 70 is mounted at arbitrary places on the host vehicle M at a position and orientation in which the head of an occupant (hereinafter, referred to as a “driver”) seated in a driver's seat of the host vehicle M can be imaged from the front (in the orientation of capturing the face). For example, the driver monitor camera 70 is mounted on an upper part of a display device provided in a central portion of an instrument panel of the host vehicle M.

The driving operator 80 includes, for example, an accelerator pedal, a brake pedal, a shift lever, and other operators, in addition to a steering wheel 82. The driving operator 80 is provided with a sensor for detecting an operation amount or the presence or absence of an operation, and its detection result is output to the automated driving control device 100, or some or all of the travel driving force output device 200, the brake device 210, and the steering device 220. The steering wheel 82 is an example of an “operator that accepts a steering operation by the driver”. The operator does not necessarily have to be annular and may be in the form of a deformed steering wheel, a joy stick, a button, and the like. The steering wheel 82 is provided with a steering grip sensor 84. The steering grip sensor 84 is implemented by a capacitance sensor and the like, and outputs, to the automated driving control device 100, a signal capable of detecting whether the driver is gripping the steering wheel 82 (indicating that the driver is in contact with the steering wheel 82 while a force is applied).

The automated driving control device 100 includes, for example, a first controller 120 and a second controller 160. Each of the first controller 120 and the second controller 160 is implemented by, for example, a hardware processor such as a CPU executing a program (software). Some or all of these components may be implemented by hardware (a circuit unit: including circuitry) such as a LSI, an ASIC, a FPGA, and a GPU, or may be implemented by software and hardware in cooperation. The program may be stored in advance in a storage device (storage device including a non-transitory storage medium) such as an HDD and a flash memory of the automated driving control device 100 or may be installed in the HDD and the flash memory of the automated driving control device 100 when a detachable storage medium (non-transitory storage medium) storing the program, such as a DVD and a CD-ROM, is mounted on a drive device. The automated driving control device 100 is an example of a “vehicle control device”.

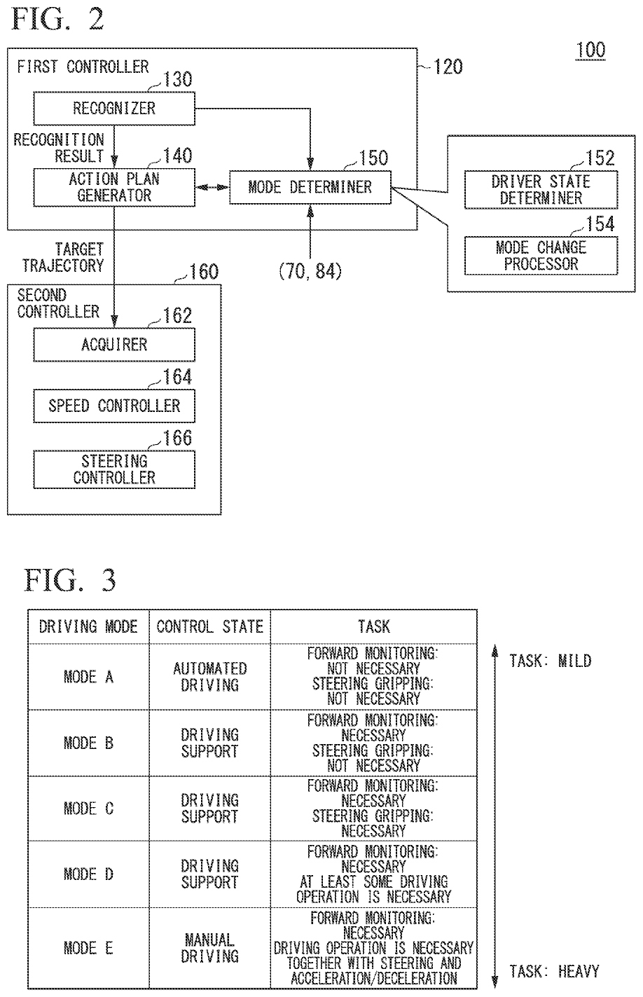

FIG. 2 is a functional configuration diagram of the first controller 120 and the second controller 160. The first controller 120 includes, for example, a recognizer 130, an action plan generator 140, and a mode determiner 150. The first controller 120 performs, for example, a function based on an artificial intelligence (AI) and a function based on a predetermined model in parallel. For example, a function of “recognizing an intersection” may be implemented by performing intersection recognition by deep learning and the like and recognition based on a predetermined condition (pattern matching signals, road markings, and the like) in parallel, or scoring both recognition and comprehensively evaluating them. In this way, the reliability of automated driving is ensured.

The recognizer 130 recognizes a state such as the position, speed, acceleration and the like of an object around the host vehicle M based on information input from the camera 10, the radar device 12, and the LIDAR 14 via the object recognition device 16. The position of the object is recognized as, for example, a position on absolute coordinates with a representative point (center of gravity, the center of the drive axis, and the like) of the host vehicle M as the origin, and is used for control. The position of the object may be represented by a representative point of the center of gravity, a corner, and the like of the object, or may be represented by an indicated area. The “state” of the object may include an acceleration, a jerk, or an “action state” (for example, whether a lane change is being performed or is intended to be performed) of the object.

The recognizer 130 recognizes, for example, a lane (a travel lane) in which the host vehicle M is traveling. For example, the recognizer 130 compares a pattern (for example, an arrangement of solid lines and broken lines) of road division lines obtained from the second map information 62 with a pattern of road division lines around the host vehicle M, which is recognized from the image captured by the camera 10, thereby recognizing the travel lane. The recognizer 130 may recognize the travel lane by recognizing not only the road division lines but also a traveling road boundary (road boundary) including the road division lines, a road shoulder, a curb, a median strip, a guardrail, and the like. In this recognition, the position of the host vehicle M acquired from the navigation device 50 or a processing result of the INS may be taken into consideration. The recognizer 130 recognizes a temporary stop line, an obstacle, a red light, a tollgate, and other road events.

When recognizing the travel lane, the recognizer 130 recognizes the position and the orientation of the host vehicle M with respect to the travel lane. The recognizer 130, for example, may recognize, as the relative position and the orientation of the host vehicle M with respect to the travel lane, a deviation of a reference point of the host vehicle M from a center of a lane and an angle formed with respect to a line connecting the center of the lane in the traveling direction of the host vehicle M. Instead of this, the recognizer 130 may recognize the position and the like of the reference point of the host vehicle M with respect to any one of the side ends (the road division line or the road boundary) of the travel lane as the relative position of the host vehicle M with respect to the travel lane.

The action plan generator 140 generates a target trajectory along which the host vehicle M will travel in the future automatically (independent of a driver's operation) to be able to travel in the recommended lane determined by the recommended lane determiner 61 in principle and further to cope with surrounding situations of the host vehicle M. The target trajectory includes, for example, a speed element. For example, the target trajectory is represented as a sequence of points (trajectory points) to be reached by the host vehicle M. The trajectory point is a point that the host vehicle M is to reach every predetermined travel distance (for example, about several meters) along a road, and a target speed and a target acceleration at every predetermined sampling time (for example, about several tenths of a [sec]) are separately generated as part of the target trajectory. Furthermore, the trajectory point may be a position that the host vehicle M is to reach at the sampling time for each predetermined sampling time. In such a case, information on the target speed and the target acceleration is represented by the interval between the trajectory points.

Specifically, in the automated driving control device 100 of the present embodiment, when it is predicted that the camera 10 will be backlit while the host vehicle is traveling, the action plan generator 140 generates an action plan (hereinafter, referred to as a “backlight avoidance plan”) for avoiding that the camera 10 is actually backlit at a point (hereinafter, referred to as a “backlight prediction point”) where it is predicted that the camera 10 will be backlit. It is assumed that the backlight prediction point includes not only the concept of position but also the concept of time. This is because even at the same point, it may be or may not be a backlight point depending on the time.

For example, the backlight avoidance plan can be classified into a first backlight avoidance plan for preventing the host vehicle from traveling through the backlight prediction point, and a second backlight avoidance plan for allowing the host vehicle to traveling through the backlight prediction point while preventing the camera 10 from being backlit. For example, the action plan generator 140 may generate, as the first backlight avoidance plan, an action plan for bypassing the backlight prediction point or an action plan for traveling through the backlight prediction point at the timing when the camera 10 is not backlit. For example, the action plan generator 140 may generate, as the second backlight avoidance plan, an action plan for positioning the camera 10 so as not to be backlit by using a surrounding environment when traveling through the backlight prediction point.

When generating the target trajectory, the action plan generator 140 may set events for automated driving. The events for automated driving include constant-speed travel events, low-speed following travel events, lane change events, branching events, merge events, takeover events, and the like. The action plan generator 140 generates the target trajectory according to an activated event.

The mode determiner 150 determines a driving mode of the host vehicle M to be any one of a plurality of driving modes in which tasks imposed on the driver are different. The mode determiner 150 includes, for example, a driver state determiner 152 and a mode change processor 154. Individual functions thereof will be described below.

FIG. 3 is a diagram showing an example of the correspondence relationships between a driving mode, a control state of the host vehicle M, and tasks. The driving mode of the host vehicle M includes, for example, five modes from mode A to mode E. The degree of automation of the control state, that is, the driving control of the host vehicle M, is the highest in the mode A, decreases in the order of the mode B, the mode C, and the mode D, and is the lowest in the mode E. In contrast, the tasks imposed on the driver are the mildest in the mode A, become heavier in the order of the mode B, the mode C, and the mode D, and are the heaviest in the mode E. In the modes D and E, since the control state is not automated driving, the automated driving control device 100 is responsible for ending control related to automated driving and shifting to driving support or manual driving. Hereinafter, details of the respective driving modes will be described.

In the mode A, the state is automated driving, so neither forward monitoring nor gripping of the steering wheel 82 (steering gripping in the drawing) is imposed on the driver. However, even in the mode A, the driver is required to be in a position to quickly shift to manual driving in response to a request from the system centered on the automated driving control device 100. The automated driving used herein indicates that both steering and acceleration/deceleration are controlled regardless of an operation of the driver. The front means a space in the traveling direction of the host vehicle M that can be visually recognized through a front windshield. The mode A is, for example, a driving mode in which the host vehicle M is traveling at a predetermined speed (for example, about 50 [km/h]) or less on a highway such as a motorway, and that is executable when a condition such as the presence of a preceding vehicle to be followed is satisfied, which may be referred to as traffic jam pilot (TJP). When the condition is not satisfied, the mode determiner 150 changes the driving mode of the host vehicle M to the mode B.

In the mode B, the state is driving support, so the driver is tasked with monitoring in front of the host vehicle M (hereinafter, forward monitoring), but is not tasked with gripping the steering wheel 82. In the mode C, it is the state of driving support, so the driver is tasked with the task of forward monitoring and the task of gripping the steering wheel 82. The mode D is a driving mode that requires a certain degree of driving operation by the driver with respect to at least one of the steering and acceleration/deceleration of the host vehicle M. For example, in the mode D, driving support such as adaptive cruise control (ACC) and lane keeping assist system (LKAS) is provided. In the mode E, it is the state of manual driving that requires a driving operation by the driver together with both steering and acceleration/deceleration. In both the mode D and the mode E, the driver is naturally tasked with monitoring in front of the host vehicle M.

The automated driving control device 100 (and a driving support device (not illustrated)) performs automatic lane change according to the driving mode. The automatic lane change includes an automatic lane change (1) according to a system request and an automatic lane change (2) according to a driver request. The automatic lane change (1) includes an automatic lane change for overtaking and an automatic lane change for traveling toward a destination (an automatic lane change due to a change in a recommended lane), which are performed when the speed of a preceding vehicle is smaller than that of the host vehicle by a reference or more. The automatic lane change (2) is for changing the lane of the host vehicle M toward the operation direction when a direction indicator is operated by the driver in a case where conditions related to the positional relationship and the like between speeds and surrounding vehicles are satisfied.

The automated driving control device 100 does not perform either the automatic lane change (1) or (2) in the mode A. The automated driving control device 100 perform both the automatic lane change (1) and (2) in the modes B and C. The driving support device (not illustrated) does not perform the automatic lane change (1) but performs the automatic lane change (2) in the mode D. In the mode E, neither the automatic lane change (1) nor (2) is performed.

When a task related to a determined driving mode (hereinafter, a current driving mode) is not being performed by the driver, the mode determiner 150 changes the driving mode of the host vehicle M to a driving mode in which tasks are heavier.

For example, in the mode A, when the driver is in a position where it is not possible to shift to manual driving in spite of a request from the system (for example, when the driver continuously looks aside outside a permissible area or when a sign of difficulty in driving is detected), the mode determiner 150 performs control for prompting the driver to shift to manual driving by using the HMI 30, and stopping automated driving by bringing the host vehicle M close to a road shoulder and gradually stopping the host vehicle M when the driver does not respond. After the automated driving is stopped, the host vehicle is in the mode D or E, and the host vehicle M can be started by a manual operation of the driver. Hereinafter, the same applies to “stop automated driving”. When the driver does not monitor the front in the mode B, the mode determiner 150 performs control for prompting the driver to monitor the front by using the HMI 30 and stopping automated driving by bringing the host vehicle M close to a road shoulder and gradually stopping the host vehicle M when the driver does not respond. In the mode C, when the driver does not monitor the front or when the driver does not grip the steering wheel 82, the mode determiner 150 performs control for prompting the driver to monitor the front and/or grip the steering wheel 82 by using the HMI 30 and stopping automated driving by bringing the host vehicle M close to a road shoulder and gradually stopping the host vehicle M when the driver does not respond.

The driver state determiner 152 monitors the state of the driver for the above mode change and determines whether the state of the driver is in a state corresponding to a task. For example, the driver state determiner 152 performs a posture estimation process by analyzing an image captured by the driver monitor camera 70 and determines whether the driver is in a position where it is not possible to shift to manual driving in spite of a request from the system. The driver state determiner 152 performs a visual line estimation process by analyzing an image captured by the driver monitor camera 70 and determines whether the driver is monitoring the front.

The mode change processor 154 performs various processes for mode change. For example, the mode change processor 154 may instruct the action plan generator 140 to generate a target trajectory for stopping at a road shoulder, give an operation instruction to the driving support device (not illustrated), or control the HMI 30 in order to prompt the driver to take action.

The second controller 160 controls the travel driving force output device 200, the brake device 210, and the steering device 220 such that the host vehicle M passes along the target trajectory generated by the action plan generator 140 at scheduled times.

Referring now back to FIG. 2, the second controller 160 includes, for example, an acquirer 162, a speed controller 164, and a steering controller 166. The acquirer 162 acquires information on the target trajectory (trajectory points) generated by the action plan generator 140 and stores the information in a memory (not shown). The speed controller 164 controls the travel driving force output device 200 or the brake device 210 based on a speed element associated with the target trajectory stored in the memory. The steering controller 166 controls the steering device 220 according to the degree of bending of the target trajectory stored in the memory. The processes of the speed controller 164 and the steering controller 166 are implemented by, for example, a combination of feedforward control and feedback control. As an example, the steering controller 166 performs a combination of feedforward control according to the curvature of a road in front of the host vehicle M and feedback control based on a deviation from the target trajectory.

The travel driving force output device 200 outputs a travel driving force (torque) for driving the vehicle to driving wheels. The travel driving force output device 200 includes, for example, a combination of an internal combustion engine, an electric motor, a transmission and the like, and an electronic controller (ECU) for controlling them. The ECU controls the aforementioned configuration according to information input from the second controller 160 or information input from the driving operator 80.

The brake device 210 includes, for example, a brake caliper, a cylinder for transferring hydraulic pressure to the brake caliper, an electric motor for generating the hydraulic pressure in the cylinder, and a brake ECU. The brake ECU controls the electric motor according to the information input from the second controller 160 or the information input from the driving operator 80, thereby allowing a brake torque corresponding to a brake operation to be output to each wheel. The brake device 210 may have a backup mechanism for transferring the hydraulic pressure generated by an operation of the brake pedal included in the driving operator 80 to the cylinder via a master cylinder. The brake device 210 is not limited to the aforementioned configuration and may be an electronically controlled hydraulic pressure brake device that controls an actuator according to the information input from the second controller 160, thereby transferring the hydraulic pressure of the master cylinder to the cylinder.

The steering device 220 includes, for example, a steering ECU and an electric motor. The electric motor, for example, changes an orientation of a steering wheel by allowing a force to act on a rack and pinion mechanism. The steering ECU drives the electric motor according to the information input from the second controller 160 or the information input from the driving operator 80, thereby changing the orientation of the steering wheel.

Hereinafter, the function of generating the backlight avoidance plan and the function of determining the backlight avoidance route will be described in more detail.

First Backlight Avoidance Plan

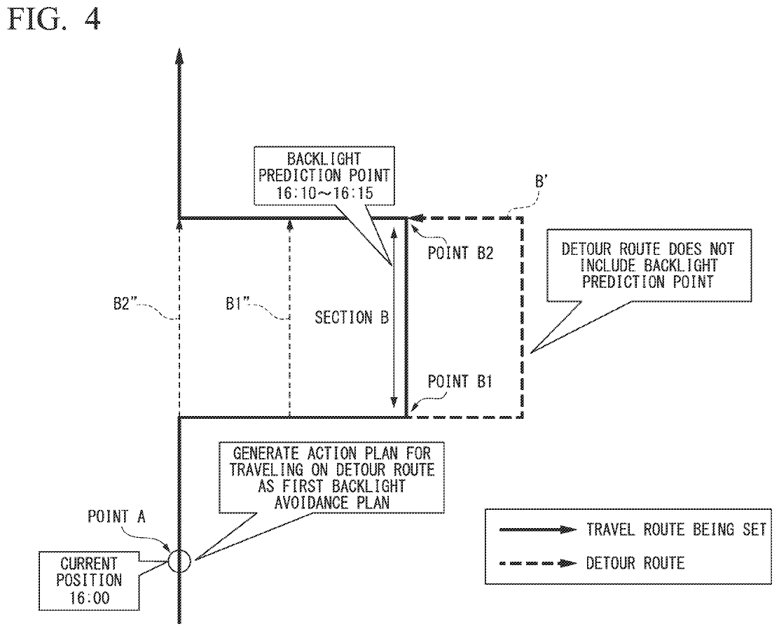

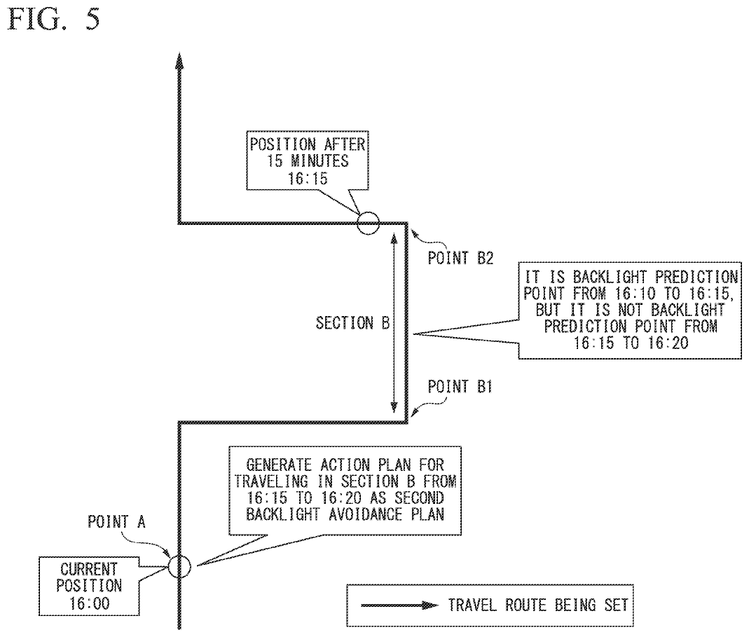

FIG. 4 and FIG. 5 are diagrams for explaining an example of the first backlight avoidance plan. First, FIG. 4 shows an example of generating an action plan for traveling on a detour route as an example of the first backlight avoidance plan. FIG. 4 shows a case where, when traveling at 16:00 at a point A on a travel route being set, it is predicted that backlight will occur in a section B scheduled to travel during the period from 16:10 to 16:15 as a result of predicting a backlight point on a route scheduled to travel by 15 minutes later.

For example, in such a case, the action plan generator 140 searches for a detour route B′ that can bypass a section B without the camera 10 being backlit, and generates an action plan for traveling on the detour route B′ instead of the section B. The action plan generator 140 generates the action plan for traveling on such a detour route, so that the host vehicle can travel to a destination without the camera 10 being backlit. Therefore, according to the automated driving control device 100 of the embodiment, it is possible to restrain the reduction of the accuracy of object detection by the camera 10.

In such a case, it is assumed that information necessary for determining a detour route is stored in the automated driving control device 100 in advance; however, when the necessary information is included in the first map information 54 or the second map information 62, the action plan generator 140 may present a search condition and cause the navigation device 50 or the MPU 60 to search for the detour route. In such a case, the navigation device 50 may reflect the detour route obtained as the search result, in a travel route being set.

FIG. 4 shows the detour route B′ from a start point B1 to an end point B2 of the section B as the detour route; however, the detour route may be determined in any way as long as it does not pass through the section B and is a route that does not cause the camera 10 to be backlit. For example, the detour route may be a route that turns left before reaching the section B (route B1″ in the drawing), or a route that goes straight from a current position in the direction of the section B without turning right (route B2″ in the drawing).

FIG. 5 shows an example of generating, as an example of the first backlight avoidance plan, an action plan for traveling through a point (position), which is estimated as a backlight prediction point, at the timing when the camera 10 is not backlit. As in the case of FIG. 4, FIG. 5 shows a case where, when traveling at 16:00 on the point A on the travel route being set, it is predicted that backlight will occur in the section B scheduled to travel during the period from 16:10 to 16:15 as a result of predicting a backlight point on a route scheduled to travel by 15 minutes later.

For example, in such a case, the action plan generator 140 examines whether there is a timing, at which the camera 10 is not backlit, at the timing other than the period from 16:10 to 16:15 which is a scheduled travel period, in the section B in which backlight is predicted. For example, in a case where it is found that the camera 10 is not backlit when traveling in the section B during the period from 16:15 to 16:20, the action plan generator 140 generates an action plan so that the section B can be traveled at the timing of 16:15 to 16:20. For example, the action plan generator 140 generates an action plan for slowing down the travel speed from the current point A to the start point B1 of the section B so as to reach the point B1 of the section B at 16:15 and traveling in the section B at a speed for reaching the end point B2 of the section B by 16:20.

By generating such a backlight avoidance plan, the action plan generator 140 can control the host vehicle so as to travel in the section B at the timing when the camera 10 is not backlit. In this way, when it is possible to prevent the camera 10 from being backlit by changing a traveling speed, it is not necessary to change a travel route being set, which makes it possible to reduce an influence of a change in an action plan. On the other hand, in such a case, since the arrival time at a destination is changed, movement conditions of an occupant may not be satisfied. Therefore, whether to adopt a generated backlight avoidance plan may be determined based on the prediction of a movement result obtained when an action plan is changed.

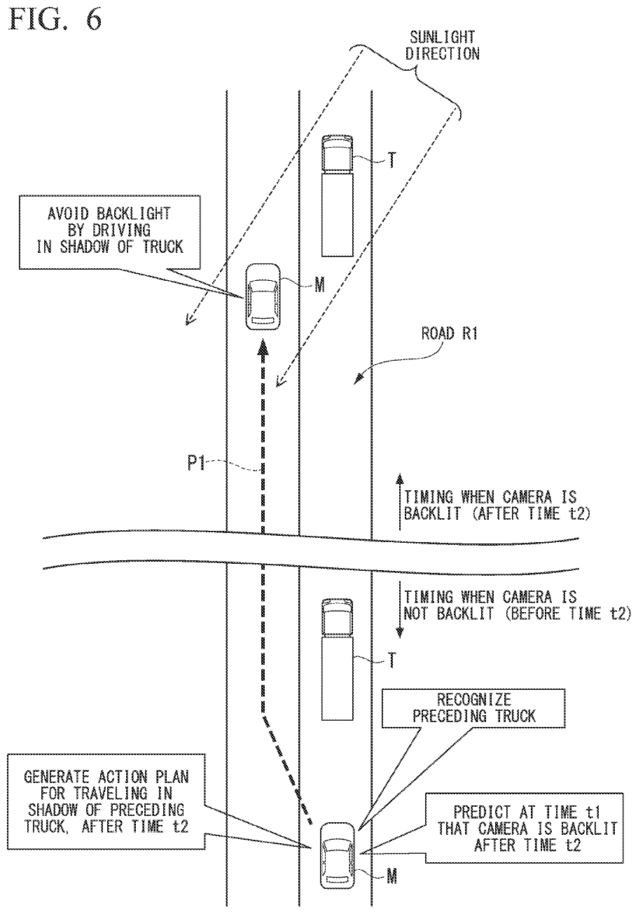

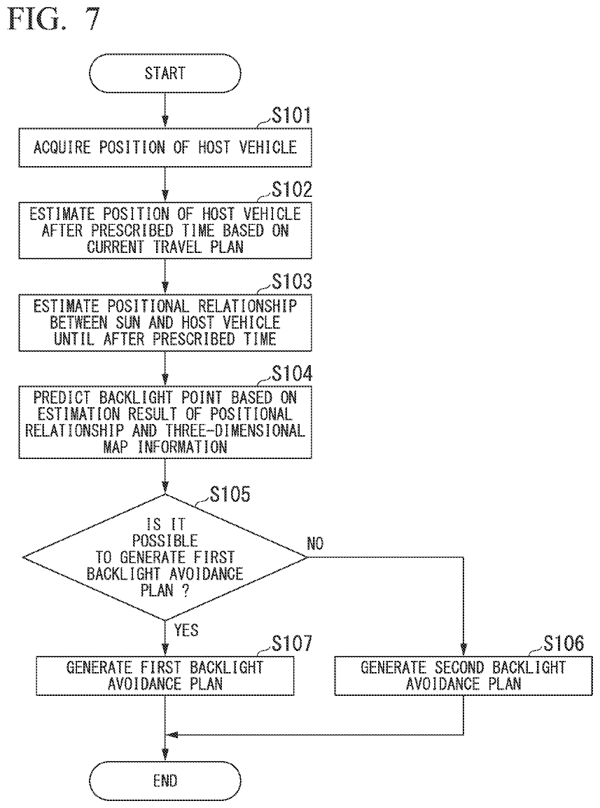

Second Backlight Avoidance Plan FIG. 6 is a diagram for explaining an example of the second backlight avoidance plan. The example of FIG. 6 represents a case where, when the host vehicle M is traveling on a road R1 on a travel route being set at time t1, it is predicted that the camera 10 will be backlit after time t2. At this time, it is assumed that the host vehicle M recognizes a truck T traveling in front of the host vehicle M by the recognizer 130.

In such a case, the action plan generator 140 generates an action plan for traveling so as to avoid the camera 10 from being backlit by hiding in a shadow of the truck T recognized in front of the host vehicle M after the time t2. Specifically, in the example of FIG. 6, the action plan generator 140 generates an action plan P1 that changes so that the positional relationship between the host vehicle M and the truck T becomes the positional relationship shown in the drawing after the time t2. Specifically, the action plan P1 in the example of FIG. 6 includes an action plan for adjusting a travelling speed and an action plan for changing a traveling lane.

In this way, when it is possible to avoid the camera 10 from being backlit by using the surrounding environment, it is not necessary to change a travel route being set, which makes it possible to reduce an influence of a change in an action plan. However, since it is possible that no object is around the host vehicle, which is available for avoiding backlight, the action plan generator 140 is not always able to generate the second backlight avoidance plan. Therefore, the action plan generator 140 may be configured to attempt to generate the first backlight avoidance plan, and then generate the second backlight avoidance plan when it is not possible to generate the first backlight avoidance plan satisfying a condition.

FIG. 7 is a flowchart showing an example of the flow of a process (hereinafter, referred to as a “first backlight avoidance process”) in which the action plan generator 140 in the automated driving control device 100 avoids backlight by generating the first backlight avoidance plan or the second backlight avoidance plan. First, the action plan generator 140 acquires position information of a host vehicle (step S101). Subsequently, the action plan generator 140 estimates the position of the host vehicle after a prescribed time based on a current travel plan (step S102). Subsequently, the action plan generator 140 estimates the positional relationship between the host vehicle and the sun at each time point until after the prescribed time (step S103). For example, the position of the sun can be calculated by a known estimation model with dates and times as variables.

Subsequently, based on the estimated positional relationship between the host vehicle and the sun and three-dimensional map information for around the host vehicle, the action plan generator 140 predicts a point, where the camera 10 is backlit, on a travel route until after the prescribed time from the current point time (step S104). Since the camera 10 is not backlit when the sunlight is blocked by clouds such as when it rains, the action plan generator 140 may be configured to acquire weather information in addition to the positional relationship between the host vehicle and the sun and the three-dimensional map information, and to estimate the presence or absence of backlight in consideration of the weather at that time.

Subsequently, the action plan generator 140 determines whether it is possible to generate the first backlight avoidance plan that can avoid traveling through a backlight prediction point (position and time) (step S105). When it is determined that it is possible to generate the first backlight avoidance plan, the action plan generator 140 generates the first backlight avoidance plan for avoiding the backlight prediction point and ends the first backlight avoidance process (step S106). On the other hand, when it is determined in step S105 that it is not possible to generate the first backlight avoidance plan, the action plan generator 140 generates the second backlight avoidance plan and ends the first backlight avoidance process (step S107). When it is not possible to generate the second backlight avoidance plan, the action plan generator 140 may be configured to perform a process of notifying a user that it is not possible to generate the second backlight avoidance plan.

In FIG. 7, the case where the action plan generator 140 generates the second backlight avoidance plan when it is not possible to generate the first backlight avoidance plan has been described; however, in such a case, there is a high possibility that a travel plan (travel route and travel timing) is changed. Therefore, when it is desired to reduce the possibility that the travel plan is changed, the action plan generator 140 may also be configured to generate the first backlight avoidance plan when it is not possible to generate the second backlight avoidance plan.

Function of Determining Backlight Avoidance Route

In the above, the case where the automated driving control device 100 avoids backlight when a host vehicle is traveling toward a destination has been described. On the other hand, hereinafter, a case where the navigation device 50 determines a travel route (backlight avoidance route) that can reach at a destination while preventing the camera 10 from being backlit will be described. A method for determining the backlight avoidance route is basically the same as the generation of the backlight avoidance plan. That is, it is sufficient if the positional relationship between the host vehicle and the sun is predicted based on the position of the host vehicle and time, a backlight prediction point is predicted based on the prediction result and three-dimensional position information, and a route for avoiding traveling through the backlight prediction point (position and time) is selected as a backlight avoidance route.

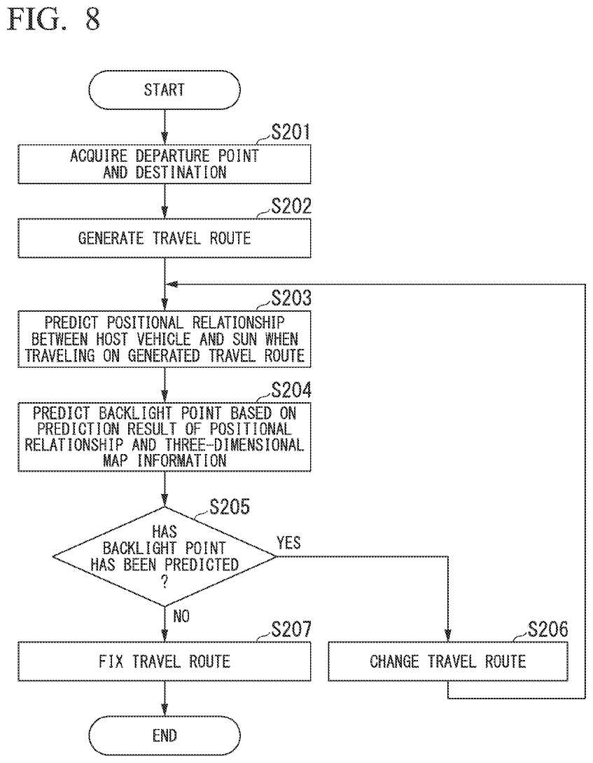

FIG. 8 is a flowchart showing an example of the flow of a process (hereinafter, referred to as a “second backlight avoidance process”) in which the route determiner 53 in the navigation device 50 determines a backlight avoidance route. First, the route determiner 53 acquires information on a departure point and a destination (step S201). For example, the route determiner 53 may accept the input of the departure point and the destination via the navigation HMI 52. Subsequently, the route determiner 53 generates a travel route from the departure point to the destination based on the acquired information on the departure point and the destination (step S202). The travel route may be arbitrarily determined in consideration of various movement conditions designated by a user in relation to an arrival time, a travel distance, a relay point, and the like. The navigation HMI 52 is an example of an “inputter”.

Subsequently, the route determiner 53 predicts the positional relationship between the host vehicle and the sun when the host vehicle is traveling on the generated travel route in step S202 (step S203) and predicts a backlight point on the travel route based on the prediction result and three-dimensional map information (step S204). The route determiner 53 determines whether the backlight point has been predicted (step S205). When it is determined that the backlight point has been predicted on the generated travel route, the route determiner 53 partially changes the travel route so as not to traveling through the predicted backlight prediction point (step S206) and returns the process to step S203. On the other hand, when it is determined in step S205 that the backlight point has not been predicted on the generated travel route, the route determiner 53 fixes the travel route at that time (step S207) and ends the second backlight avoidance process.

The automated driving control device 100 of the embodiment configured as described above includes the recognizer 130 that recognizes a situation around a host vehicle based on a detection result of an object detection device including the camera 10 and the action plan generator 140 that generates an action plan of the host vehicle based on a recognition result around the host vehicle by the recognizer 130. When it is predicted that the camera 10 will be backlit when the host vehicle is traveling, the action plan generator 140 generates an action plan for avoiding that the camera 10 is backlit at a backlight prediction point (prediction point and prediction timing) when it is predicted that the camera 10 will be backlit. This can restrain the reduction of detection accuracy of the camera 10, so that it is possible to improve the robustness of a driving support function.

The navigation device 50 of the embodiment configured as described above includes the route determiner 53 that determines a travel route from a departure point to a destination based on information on the departure point and the destination, and map information including a road shape. The route determiner 53 predicts the positional relationship between the host vehicle and the sun based on the position of the host vehicle and time and determines a travel route for preventing the camera 10 mounted on the host vehicle to capture an image of an area in front of the host vehicle from being backlit, based on the prediction result of the positional relationship and three-dimensional map information for around the position of the host vehicle. This can restrain the host vehicle from traveling on a travel route in which the detection accuracy of the camera 10 is reduced, so that it is possible to improve the robustness of a driving support function.

Although a mode for carrying out the present invention has been described using the embodiments, the present invention is not limited to these embodiments and various modifications and substitutions can be made without departing from the spirit of the present invention.

What is claimed is:

1. A vehicle control device comprising:
a storage device configured to store a program; and
a hardware processor,
wherein the hardware processor executes the program stored in the storage device to perform a recognition process of recognizing a situation around a host vehicle based on a detection result of an object detection device including a camera and an action plan generation process of generating an action plan of the host vehicle based on a recognition result of the situation around the host vehicle, and
in the action plan generation process, the hardware processor generates an action plan for, when it is predicted that the camera will be backlit while the host vehicle is traveling, avoiding that the camera is backlit at a prediction point and a prediction timing when it is predicted that the camera will be backlit.

2. The vehicle control device according to claim 1, wherein the hardware processor generates a first backlight avoidance plan that is an action plan for preventing the host vehicle from traveling through the prediction point at the prediction timing, or a second backlight avoidance plan for traveling through the prediction point while positioning the camera so as not to be backlit by using a surrounding environment of the host vehicle at the prediction timing.

3. The vehicle control device according to claim 2, wherein the hardware processor generates an action plan for bypassing the prediction point as the first backlight avoidance plan.

4. The vehicle control device according to claim 2, wherein the hardware processor generates an action plan for traveling through the prediction point at a timing when the camera is not backlit, as the first backlight avoidance plan.

5. The vehicle control device according to claim 2, wherein the hardware processor generates an action plan for positioning the host vehicle to travel in a shadow of another vehicle present around the host vehicle, as the second backlight avoidance plan.

6. The vehicle control device according to claim 1, wherein the hardware processor predicts a positional relationship between the host vehicle and the sun based on a position of the host vehicle and time and determines whether the camera will be backlit based on a prediction result of the positional relationship and three-dimensional map information for around the position of the host vehicle.

7. A vehicle control method implemented by a computer that performs:
an external recognition process of recognizing a situation around a host vehicle based on a detection result of an object detection device including a camera; and
an action plan generation process of generating an action plan of the host vehicle based on a recognition result of a situation around the host vehicle,
wherein, in the action plan generation process, the hardware processor generates an action plan for, when it is predicted that the camera will be backlit while the host vehicle is traveling, avoiding that the camera is backlit at a prediction point and a prediction timing when it is predicted that the camera will be backlit.

8. A non-transitory computer readable storing medium storing a program causing a computer to perform:
an external recognition process of recognizing a situation around a host vehicle based on a detection result of an object detection device including a camera; and
an action plan generation process of generating an action plan of the host vehicle based on a recognition result of a situation around the host vehicle,
wherein, in the action plan generation process, the hardware processor generates an action plan for, when it is predicted that the camera will be backlit while the host vehicle is traveling, avoiding that the camera is backlit at a prediction point and a prediction timing when it is predicted that the camera will be backlit.

9. A route generation device comprising:
a storage device configured to store a program; and
a hardware processor,
wherein the hardware processor executes the program stored in the storage device to perform a route determination process of accepting input of information on a departure point and a destination and determining a travel route from the departure point to the destination based on the input information on the departure point and the destination and map information including a road shape,
wherein, in the route determination process, the hardware processor predicts a positional relationship between a host vehicle and the sun based on a position of the host vehicle and time and determines a travel route for preventing a camera mounted on the host vehicle to capture an image of an area in front of the host vehicle from being backlit, based on a prediction result of the positional relationship and three-dimensional map information for around the position of the host vehicle.

10. A route generation method implemented by a computer that performs:
a route determination process of receiving information on a departure point and a destination and determining a travel route from the departure point to the destination based on the input information on the departure point and the destination and map information including a road shape,
wherein, in the route determination process, the hardware processor predicts a positional relationship between a host vehicle and the sun based on a position of the host vehicle and time and determines a travel route for preventing a camera mounted on the host vehicle to capture an image of an area in front of the host vehicle from being backlit, based on a prediction result of the positional relationship and three-dimensional map information for around the position of the host vehicle.

11. A non-transitory computer readable storing medium storing a program causing a computer to perform:
a route determination process of receiving information on a departure point and a destination and determining a travel route from the departure point to the destination based on the input information on the departure point and the destination and map information including a road shape,
wherein, in the route determination process, the hardware processor predicts a positional relationship between a host vehicle and the sun based on a position of the host vehicle and time and determines a travel route for preventing a camera mounted on the host vehicle to capture an image of an area in front of the host vehicle from being backlit, based on a prediction result of the positional relationship and three-dimensional map information for around the position of the host vehicle.
